(19) United States
(12) Patent Application Publication
(10) Pub. No.: US 2020/0086295 A1
(43) Pub. Date: Mar. 19, 2020

(54) ANIONIC SUBSTANCE-ADSORBING AGENT, METHOD FOR PRODUCING ANIONIC SUBSTANCE-ADSORBING AGENT, APPARATUS FOR PRODUCING ANIONIC SUBSTANCE-ADSORBING AGENT, AND METHOD FOR RECOVERING ANIONIC SUBSTANCES

(71) Applicant: JFR CO., LTD., Tokyo (JP)

(72) Inventors: Hiroshi MIYAZAKI, Tokyo (JP); Akira FUJINO, Chiba (JP)

(73) Assignee: JFR CO., LTD., Tokyo (JP)

(21) Appl. No.: 16/470,729

(22) PCT Filed: Dec. 19, 2017
(86) PCT No.: PCT/JP2017/045497

§ 371 Date: Jun. 18, 2019

(30) Foreign Application Priority Data
Dec. 19, 2016 (JP) 2016-245569
Aug. 24, 2017 (JP) 2017-161168

(51) Int. Cl. B01J 20/10; B01J 20/28; B01J 20/30; C02F 1/28

(52) U.S. Cl. CPC B01J 20/10; B01J 20/28057; C02F 2101/105; B01J 20/3085; C02F 1/281; B01J 20/28076

(57) ABSTRACT

An anionic substance-adsorbing agent having an excellent ability to adsorb anionic substances; a method for producing the anionic substance-adsorbing agent; an apparatus for producing the anionic substance-adsorbing agent; and a method for recovering anionic substances. The present invention pertains to an anionic substance-adsorbing agent which contains foam glass, wherein, as determined by XPS analysis, the concentration of Ca2P is at least 4.0 at % or the concentration of Na1s is at most 8.0 at % on the surface of the adsorbing agent, and the full width at half maximum of the Si2p peak is at least 2.4 eV. The adsorbing agent can have a specific surface area of 15 m2/g or greater or a pore volume of 1.7 cm3/g or greater as measured by mercury intrusion porosimetry.

### TECHNICAL FIELD

The present invention relates to an anionic substance-adsorbing agent, a method for producing an anionic substance-adsorbing agent, an apparatus for producing an anionic substance-adsorbing agent, and a method for recovering anionic substances.

### BACKGROUND ART

A technique for recovering industrially generated anionic substances (phosphoric acid ion, fluorine, boric acid, etc.) has been conventionally demanded. Phosphorus for example is an essential element for the growth of farm products, and phosphoric acid has been conventionally used as a fertilizer. When phosphoric acid used as e.g. a fertilizer as described above disappears into drainage as phosphoric acid ion and flows into an enclosed water area, eutrophication occurs in the water area and an ecosystem changes due to the phenomenon. Damage to water and damage to the fishing industry occur due to such change in the ecosystem, which has been a problem. On the other hand, phosphoric acid is generally produced using a phosphate rock as a raw material; however, phosphate rock reserves are limited, and a possibility that phosphate rocks will run dry in the near future has been pointed out. Therefore, a technique for recovering phosphoric acid from a solution including phosphoric acid such as drainage has been required to solve the problems of damage to water and damage to the fishing industry due to phosphoric acid and simultaneously effectively acquire a phosphorus resource.

On the other hand, more than a million tons of used glass annually are not recycled and are discarded by e.g. reclamation in Japan. In particular, when producing home appliances made using a glass and automotive glasses such as a rearview mirror, a large amount of waste glass is generated. In addition, it is expected that a large amount of waste glass is further generated due to disposal of glass products such as solar panels in the future. Although these waste glasses are discarded by reclamation, there are concerns about, for example, the problem of contaminated land, and the problem of building waste disposal plants sometimes in the future due to reclamation. This waste problem has been currently a social problem, and it is required to find a novel method for effectively using waste glasses.

In these circumstances, Patent Document 1 supposes a method for producing a phosphoric acid ion-adsorbing agent, the method including the step of heating treatment under pressure at a temperature of 110° C. or higher with foam glass immersed in an alkaline solution as a technique for using waste glasses and simultaneously recovering phosphoric acid.
Patent Document 1: Japanese Unexamined Patent Application, Publication No. 2011-161398

### DISCLOSURE OF THE INVENTION

### Problems to be Solved by the Invention

The anionic substance-adsorbing agent produced by the method described in Patent Document 1, however, has not had a sufficient ability to adsorb anionic substances yet and has room for improvement. In addition, production by the method described in Patent Document 1 requires a prolonged time, two hours or more, which is an industrial problem.

The present invention was made in view of the above circumstances, and an object thereof is to provide an anionic substance-adsorbing agent with an excellent ability to adsorb anionic substances, a method for producing the same, and an apparatus for producing anionic substance-adsorbing agent. Another object of the present invention is to provide a method for recovering anionic substances.

### Means for Solving the Problems

The present inventors found that an excellent ability to adsorb anionic substances could be regulated by adjusting the concentration of Ca, the concentration of Na, and the amount of SiOX (X is hydrogen, sodium, potassium or the like) on the surface of an anionic substance-adsorbing agent. In addition, the present inventors found that an anionic substance-adsorbing agent with a high ability to adsorb phosphoric acid ion (hereinafter, can be simply referred to as “adsorbing agent”) was obtained for a shorter time by a high temperature alkali treatment or a high pressure treatment of foam glass in an alkaline solution, thereby completing the present invention. More specifically, the present invention provides the following.

(1) An anionic substance-adsorbing agent, which contains foam glass, wherein by XPS analysis the concentration of Ca2p is 4.0 at % or more or the concentration of Na1s is 8.0 at % or less on the surface of the adsorbing agent, and the full width at half maximum of the Si2p peak is 2.4 eV or more.

(2) The adsorbing agent according to (1), wherein by a mercury intrusion method the specific surface area is 15 m²/g or more or the pore volume is 1.7 cm³/g or more.

(3) The adsorbing agent according to (1) or (2), wherein the specific gravity is 0.60 g/mL or less.

(4) The adsorbing agent according to any of (1) to (3), wherein the amount of phosphoric acid ion which can be adsorbed in a phosphoric acid ion solution with a concentration of phosphoric acid ion of 3000 mg/L or more is 10 mg/g or more.

(5) A method for producing an anionic substance-adsorbing agent, the method having the step of treating a foam glass material in an alkaline solution including an alkali metal hydroxide in an amount of 4 mol/L or more and having 130° C. or higher over a time required.

(6) The method according to (5), wherein the time required is within 1.5 hours.

(7) A method for producing an anionic substance-adsorbing agent, the method having the step of applying high pressure to a foam glass material in an alkaline solution under the condition of 100 atmospheres or more within 1.5 hours.

(8) The method according to any of (5) to (7), wherein the foam glass material has been foamed with a foaming agent including calcium carbonate.

(9) An apparatus for producing an anionic substance-adsorbing agent, the apparatus including a means for treating a foam glass material in an alkaline solution including an alkali metal hydroxide in an amount of 4 mol/L or more and having 130° C. or higher over a time required.

(10) An apparatus for producing an anionic substance-adsorbing agent, the apparatus including a means which can apply high pressure to a foam glass material in an alkaline solution under the condition of 100 atmospheres or more within 1.5 hours.

(11) A method for recovering anionic substances, the method having the step of adsorbing anionic substances to an adsorbing agent according to (1) to (4), or an adsorbing agent produced by a method according to any of (5) to (8).

### Effects of the Invention

According to the present invention, it is possible to provide an anionic substance-adsorbing agent with an excellent ability to adsorb anionic substances, a method for producing the same, and an apparatus for producing an anionic substance-adsorbing agent. In addition, according to the present invention, it is possible to provide a method for recovering anionic substances.

### BRIEF DESCRIPTION OF THE DRAWINGS

FIG. 1 is a graph which shows a relationship between the concentration of Ca2p on the surface of an adsorbing agent and the adsorbed phosphorus amount.

FIG. 2 is a graph which shows a relationship between the concentration of Na1s on the surface of an adsorbing agent and the adsorbed phosphorus amount.

FIG. 3 is a graph which shows the XPS analysis results of a foam glass material.

FIG. 4 is a graph which shows the XPS analysis results of an adsorbing agent (foam glass).

FIG. 5 is a graph which shows a relationship between the specific surface area of an adsorbing agent and the adsorbed phosphorus amount.

FIG. 6 is a graph which shows a relationship between the pore volume of an adsorbing agent and the adsorbed phosphorus amount.

FIG. 7 is a graph which shows a relationship between the specific gravity of an adsorbing agent and the adsorbed phosphorus amount.

FIG. 8 is a graph which shows a relationship between the treatment time of an adsorbing agent to adsorb phosphorus and the adsorbed phosphorus amount.

FIG. 9 is a graph which shows a relationship between the concentration of NaOH in an alkaline solution and the adsorbed phosphorus amount.

FIG. 10 is a graph which shows a relationship between the temperature of an alkaline solution and the adsorbed phosphorus amount.

FIG. 11 is a graph which shows a relationship between the treatment time of a high temperature alkali treatment and the adsorbed phosphorus amount.

FIG. 12 is a graph which shows a relationship between the treatment pressure of high pressure treatment and the adsorbed phosphorus amount.

### PREFERRED MODE FOR CARRYING OUT THE INVENTION

Embodiments of the present invention will now be described. It should be noted, however, that the present invention is not limited thereto.

### <Anionic Substance-Adsorbing Agent>

The anionic substance-adsorbing agent of the present invention contains foam glass, and, by X-ray photoelectron spectroscopy (XPS) analysis, the concentration of Ca2p is 4.0 at % or more or the concentration of Na1s is 8.0 at % or less on the surface of the adsorbing agent and the full width at half maximum of the Si2p peak is 2.4 eV or more.

Because the concentration of Ca2p on the surface is high, 4.0 at % or more, the adsorbing agent of the present invention can effectively adsorb anionic substances, and particularly can effectively adsorb anionic substances in the high concentration range. In addition, the concentration of Na1s on the surface is low, 8.0 at % or less, that makes the concentration of Ca2p high. When the amount of Na, which does not contribute to adsorption to anionic substances, is low and Ca is effectively exposed, anionic substances can be effectively adsorbed. Furthermore, the full width at half maximum of the Si2p peak is large, 2.4 eV or more, which shows that Si, which makes the basic skeleton of foam glass, forms more SiOX (X is hydrogen, sodium, calcium or the like) than SiO₂ on the surface of the adsorbing agent, and shows that, even when an alkali treatment is carried out at a high temperature, SiOX as the basic skeleton of foam glass is not destroyed and a function as an adsorbing agent can be shown. SiOX contributes to adsorption to anionic substances, and particularly can effectively adsorb anionic substances in the low concentration range. As described above, it was revealed that an adsorbing agent in which the concentration of Ca2p, the concentration of Na1s, and the full width at half maximum of the Si2p peak are provided in the above ranges, could show an excellent ability to adsorb anionic substances in the whole concentration range of anionic substances from the low concentration range to the high concentration range.

From the above-described viewpoint, the concentration of Ca2p on the surface of the adsorbing agent of the present invention is 4.0 at % or more, preferably 6.0 at % or more, more preferably 8.0 at % or more, and further preferably 10 at % or more. On the other hand, the upper limit of the concentration of Ca2p may be, for example, 20 at % or less (18 at % or less, 16 at % or less, 14 at % or less or the like) depending on the adsorption ability required (particularly phosphoric acid ion and fluoride ion).

In addition, from the above-described viewpoint, the concentration of Na1s on the surface of the adsorbing agent of the present invention is 8.0 at % or less, preferably 6.0 at % or less, and more preferably 4.0 at % or less. On the other hand, the lower limit of the concentration of Na1s may be, for example, zero (not more than the detection limit value) or more (1.0 at % or more, 1.5 at % or more or the like) depending on the adsorption ability required.

In addition, from the above-described viewpoint, the full width at half maximum of the Si2p peak of the adsorbing agent of the present invention is 2.4 eV or more, preferably 2.7 eV or more, and more preferably 3.0 eV or more. On the other hand, the upper limit of the full width at half maximum of the Si2p peak may be, for example, 4.0 eV or less (3.8 eV or less, 3.6 eV or less or the like) depending on the adsorption ability required. It should be noted that the peak disappears when the basic skeleton is destroyed.

Furthermore, as the specific surface area or pore volume in the adsorbing agent of the present invention increases, the surface with an ability to adsorb anionic substances increases. From this viewpoint, the specific surface area of the adsorbing agent of the present invention by a mercury intrusion method is preferably 15 m²/g or more, more preferably 30 m²/g or more, further preferably 45 m²/g or more, still more preferably 60 m²/g or more, and particularly preferably 75 m²/g or more. In addition, the pore volume of the adsorbing agent of the present invention by a mercury intrusion method is preferably 1.7 cm³/g or more, more preferably 2.0 cm³/g or more, further preferably 2.5 cm³/g or more, still more preferably 3.0 cm³/g or more, and particularly preferably 3.5 cm³/g or more. On the other hand, the upper limit of the specific surface area may be, for example, 200 m²/g or less or 150 m²/g or less depending on the adsorption ability required. The upper limit of the pore volume may be, for example, 8 cm³/g or less or 6 cm³/g or less depending on the adsorption ability required.

In addition, as the specific gravity in the adsorbing agent of the present invention decreases, the surface with an ability to adsorb anionic substances increases. From this viewpoint, the specific gravity of the adsorbing agent of the present invention is preferably 0.60 g/mL or less, more preferably 0.55 g/mL or less, and still more preferably 0.50 g/mL or less. On the other hand, the lower limit of the specific gravity may be, for example, 0.1 g/mL or more (0.15 g/mL or more, 0.2 g/mL or more, 0.25 g/mL or more or the like) depending on the adsorption ability required.

The specific gravity (g/mL) of the adsorbing agent of the present invention is measured by the following method.

(1) 5 to 10 g of adsorbing agent (for example, an adsorbing agent with a particle diameter of 4 mm or more and 10 mm or less) is taken using a scale,
(2) The taken adsorbing agent is immersed in water for about 10 minutes,
(3) The absorbent is drained into e.g. a colander 10 minutes after the onset of immersion, and water on the surface is removed with e.g. tissue,
(4) The adsorbing agent is added to a measuring cylinder with water up to half of the maximum scale value and is sunk in water,
(5) The volume of water when all the adsorbing agent is sunk is measured, and an increment from the addition is calculated, and
(6) The specific gravity is calculated using the following formula:

[specific gravity (g/mL)]=[mass of adsorbing agent (g)]/[increment in water volume (mL)].

The adsorbing agent of the present invention can adsorb phosphoric acid ion in an amount of, for example, 10.0 mg/g or more (20.0 mg/g or more, 30.0 mg/g or more, 40.0 mg/g or more, 50.0 mg/g or more, 60.0 mg/g or more, 70.0 mg/g or more, or the like) in a phosphoric acid ion solution with a concentration of phosphoric acid ion of 3000 mg/L (hereinafter, can be referred to as “high concentration phosphoric acid ion solution”). On the other hand, the upper limit of the amount of phosphoric acid ion which can be adsorbed by the adsorbing agent may be, for example, 300 mg/g or less (250 mg/g or less, 200 mg/g or less, 150 mg/g or less, 100 mg/g or less, 50.0 mg/g or less, or the like) depending on the ability to adsorb phosphoric acid ion required. It should be noted that the amount of phosphoric acid ion which can be adsorbed is just an index to an adsorption ability of the anionic substance-adsorbing agent.

In the present invention, the amount of phosphoric acid ion which can be adsorbed in a phosphoric acid ion solution with a concentration of phosphoric acid ion of 3000 mg/L is measured by the following method.

[Amount of Phosphoric Acid Ion which can be Adsorbed in High Concentration Phosphoric Acid Ion Solution]
(1) To a container, 2.50 g, 1.20 g, or 0.5 g of adsorbing agent and 50 mL of a phosphoric acid ion solution with a concentration of phosphoric acid ion (PO₄³⁻) of 3000 mg/L are added,
(2) After addition, hydrochloric acid or a sodium hydroxide solution is added to the container to adjust pH to a desired pH,
(3) After the pH adjustment the container is stirred in a thermostatic bath set to 25° C. for 2 hours,
(4) Centrifugation is carried out at 3000 rpm for 10 minutes after stirring and the concentration of phosphoric acid ion in a supernatant liquid is measured with an absorptiometer by a molybdenum blue method, and
(5) The amount of phosphoric acid ion (mg/g) which can be adsorbed is found based on the measurement value.

The adsorbing agent of the present invention is not particularly limited, as long as it is used to adsorb anionic substances. Examples of anionic substances to be adsorbed include phosphorus (e.g. phosphoric acid ion), fluorine (e.g. fluoride ion), boric acid, and the like. The present invention is particularly suitable to adsorb phosphoric acid ion and fluoride ion.

In addition, the adsorbing agent of the present invention may be formed from only foam glass having the above-described characteristics, or may include other substances and components. For example, the adsorbing agent of the present invention may include other substances having an ability to adsorb anionic substances (for example, foam glass different from foam glass having the above-described characteristics).

### <Method for Producing Anionic Substance-Adsorbing Agent According to First Embodiment>

The method for producing an anionic substance-adsorbing agent according to a first embodiment has the step of treating a foam glass material in an alkaline solution including an alkali metal hydroxide in an amount of 4 mol/L or more and having 130° C. or higher over the time required (hereinafter can be referred to as a “high temperature alkali treatment”). An adsorbing agent including foam glass having the above-described characteristics can be produced by this method.

The foam glass material in the present invention is a glass having a plurality of pores, and can be produced, for example, by pulverizing a glass as a raw material, mixing the pulverized glass and a foaming agent and then burning the mixture. An example of the method for producing a foam glass material will now be described in more detail.

The type of glass as a raw material for the foam glass material in the present invention (hereinafter, can be referred to as “material glass”) is not particularly limited, and examples thereof include soda-lime glass, borosilicate glass, aluminosilicate glass and the like. As the material glass, waste glasses derived from home appliances made using a glass such as liquid crystals and plasma displays and automotive glasses such as a rearview mirror may be used. The method for pulverizing a material glass is not particularly limited, and pulverization can be carried out using e.g. a commercially available vibrational mill. The particle diameter of a material glass after pulverization (hereinafter, can be referred to as “pulverized glass”) is not particularly limited, and is preferably smaller so that a pulverized glass and a foaming agent are uniformly mixed. It is preferred that the particle diameter of a pulverized glass be 500 μm or less, for example, by screening a particle size using a sieve with an opening of 500 μm or less after pulverizing the material glass. It should be noted that “the particle diameter is X μm or less” in the description means particles which pass through a sieve with a sieve opening of X μm.

The type of foaming agent mixed with a pulverized glass is not particularly limited, and, for example, SiC, SiN, CaCO₃, or a material including e.g. CaCO₃ (e.g. shells, etc.) can be used. In particular, CaCO₃ including Ca and a material including e.g. CaCO₃ are preferably used because foam glass having the above-described characteristics is easily obtained. These foaming agents generate gas at a temperature at which a glass is softened, and accordingly a large number of pores are formed in the inner part of the glass to produce a foam glass material. In addition, the concentration of Ca on a foam glass surface can be increased by using a foaming agent including Ca. The amount of foaming agent included is not particularly limited, and is preferably 0.1 to 5 wt %, and particularly preferably 0.2 to 2.0 wt %. As the reason, foaming sufficiently occurs and a reduction in the strength of a foam glass material due to excess foaming can be avoided within this range. In addition, when mixing a pulverized glass and a foaming agent, a material including at least one of calcium, magnesium and iron, for example, may be added separately from the foaming agent. Examples of such materials include calcium hydroxide, magnesium carbonate, magnesium hydroxide, bengara, ferrite and the like. The amount of these materials added is not particularly limited, and is preferably 1 to 20 wt %, and particularly preferably 5 to 15 wt %. An improvement in the amount of anionic substances (particularly phosphoric acid ion and fluoride ion) adsorbed is remarkable by adding these materials within the above ranges.

The burning temperature and time of the mixed material glass (pulverized glass) and foaming agent may be properly set depending on the types of material glass and foaming agent so that the material glass will be adequately foamed. The burning temperature may be, for example, 600 to 1150° C., and is preferably 800 to 1000° C. particularly when soda-lime glass is used as a material glass. When the burning temperature is within the range, because a material glass is sufficiently softened to adequately form pores and the material glass is not too soft, clogging of the formed pores can be avoided. In addition, the burning time may be, for example, 1 to 60 minutes, and is preferably 5 to 10 minutes. When the burning time is within this range, foaming sufficiently occurs, and clogging of the formed pores and the disappearance of surface fineness due to foams sticking to each other can be avoided.

The form of a foam glass material is not particularly limited, and may remain in the form of block, or may be pulverized. The particle diameter of the pulverized foam glass material is not particularly limited, and is preferably 2 cm or less, further preferably 1 cm or less, and further preferably 0.6 cm or less.

### [Step of High Temperature Alkali Treatment]

The alkaline solution used in a high temperature alkali treatment is a solution obtained by dissolving a solute, which is dissolved in water to generate hydroxy group, in water. The type of solute in an alkaline solution is not particularly limited, and, for example, an alkaline solution of one or more selected from the group consisting of NaOH, KOH, Na₂CO₃ and Ca(OH)₂ can be used. Among these, an alkali metal hydroxide such as NaOH or KOH, a strong alkali, is particularly preferred.

The amount of alkali metal hydroxide in an alkaline solution is 4 mol/L or more, preferably 5 mol/L or more, and more preferably 6 mol/L or more to obtain foam glass having the above-described characteristics. In a conventional method for producing an adsorbing agent including foam glass, generally even when the amount of alkali metal hydroxide is increased to for example 4 mol/L or more, the amount of anionic substances adsorbed by foam glass is saturated. According to the method for producing the adsorbing agent of the present invention, however, it was revealed that, because a treatment at a high temperature, 130° C. or higher, was carried out, as the amount of alkali metal hydroxide was increased, the amount of anionic substances adsorbed by foam glass could increase. Various reasons of this can be thought, and it is thought that in a conventional production method, for example, the reaction of a foam glass material and an alkali metal hydroxide is insufficient due to an insufficient temperature, and the concentration of Ca in a foam glass material is insufficient. On the contrary, when the method for producing the adsorbing agent of the present invention meets the above-described conditions, the surface of foam glass having an ability to adsorb anionic substances increases, and the amount of anionic substances adsorbed can be greater than that of conventional adsorbing agents. On the other hand, the upper limit of the amount of alkali metal hydroxide may be, for example, 19 mol/L or less (18 mol/L or less, 17 mol/L or less or the like) depending on the adsorption ability required.

The temperature of an alkaline solution is 130° C. or higher, more preferably 140° C. or higher, further preferably 150° C. or higher, still more preferably 160° C. or higher, and particularly preferably 170° C. or higher to obtain foam glass having the above-described characteristics. In a conventional method for producing an adsorbing agent including foam glass, generally even when the temperature of an alkaline solution is increased to for example 130° C. or higher, the amount of anionic substances adsorbed by foam glass is saturated. According to the method for producing the adsorbing agent of the present invention, however, it was revealed that, because a treatment was carried out using an alkali metal hydroxide in an amount of 4 mol/L or more, as the temperature of the alkaline solution was increased, the amount of anionic substances adsorbed by foam glass could increase. Various reasons of this can be thought, and it is thought that in a conventional production method, for example, the reaction of a foam glass material and an alkali metal hydroxide is insufficient due to an insufficient amount of alkali metal hydroxide, and the concentration of Ca in a foam glass material is insufficient. On the contrary, when the method for producing the adsorbing agent of the present invention meets the above-described conditions, the surface of foam glass having an ability to adsorb anionic substances increases, and the amount of anionic substances adsorbed can be greater than that of conventional adsorbing agents. On the other hand, the upper limit of the temperature of an alkaline solution is not particularly limited; however, because a higher temperature increases a risk and also increases energy consumption, the temperature may be, for example, 300° C. or lower (280° C. or lower, 260° C. or lower, or the like). In addition, it is only required to be 130° C. or higher at least in a part of the step of high temperature alkali treatment in the present invention, and the step of heating under the condition of lower than 130° C. may be included.

The time required for the treatment by an alkaline solution is within 1.5 hours (e.g. within 1.2 hours, 1.0 hour, 50 minutes, 40 minutes, 30 minutes, 20 minutes, 10 minutes, 5 minutes, a minute, or the like). The method for producing the adsorbing agent of the present invention is simple and easy because foam glass having an excellent ability to adsorb anionic substances can be produced for such a short period of time. The lower limit of the treatment time under the above-described conditions may be, for example, 10 seconds or more, 30 seconds or more, a minute or more, 10 minutes or more, 30 minutes or more, and an hour or more depending on the adsorption ability required.

It should be noted that the above-described step of high temperature alkali treatment is preferably carried out under pressure. The method for applying pressure is not particularly limited, and application of pressure may be carried out by using a device to apply pressure, or by heating with foam glass and an alkaline solution put in a closed container. In the former case, because the pressure applied can be optionally changed, the pressure applied can be increased even in a case where the heating temperature is relatively low. In the latter case, when an alkaline solution is heated to 100° C. or higher, pressure is applied to the alkaline solution due to the vapor pressure of water included in the alkaline solution. According to the latter method, pressure can be applied to an alkaline solution without using a special device.

It should be noted that, in a case where pressure is applied to an alkaline solution using a closed container, considering that the saturated vapor pressure of water at 110° C. is almost 1.4 atmospheres and there is slight vapor leakage in a closed container, the pressure is preferably 1.2 atmospheres or more, further preferably 1.4 atmospheres or more, and particularly preferably 2 atmospheres or more. The upper limit of pressure in the present embodiment is not particularly restricted; however, it is preferred that pressure be applied without using the above-described device to apply pressure in view of costs. The upper limit is, for example, preferably 95 atmospheres or less, and further preferably 70 atmospheres or less. It should be noted that the saturated vapor pressure of water at 300° C. is almost 95 atmospheres.

### <Method for Producing Anionic Substance-Adsorbing Agent According to Second Embodiment>

The method for producing an anionic substance-adsorbing agent according to a second embodiment has the step of treating a foam glass material at high pressure in an alkaline solution under the condition of 100 atmospheres or more within 1.5 hours (hereinafter, can be referred to as “high pressure treatment”). An adsorbing agent including foam glass having the above-described characteristics can be produced by this method. In the description “high pressure” indicates applying pressure at 100 atmospheres or more.

### [Step of High Pressure Treatment]

The atmospheric pressure in the step of high pressure treatment is not particularly limited under the condition of 100 atmospheres or more, and the atmospheric pressure may be properly set depending on a desired adsorption ability of an adsorbing agent. The atmospheric pressure is, for example, preferably 200 atmospheres or more, more preferably 400 atmospheres or more, further preferably 600 atmospheres or more, still more preferably 800 atmospheres or more, and particularly preferably 1000 atmospheres or more from the viewpoint of obtaining foam glass with the above-described characteristics. On the other hand, the upper limit of pressure in the high pressure step may be, for example, 20000 atmospheres or less (15000 atmospheres or less, 10000 atmospheres or less, 5000 atmospheres or less, 2000 atmospheres or less, 1500 atmospheres or less, or the like). In addition, it is only required to be 100 atmospheres or more at least in a part of the high pressure step in the present invention, and the pressure step under the condition of less than 100 atmospheres may be also included.

The step of high pressure treatment is simple and easy because foam glass having an ability to adsorb anionic substances can be produced by applying high pressure (under the condition of 100 atmospheres or more) for a short period of time within 1.5 hours (e.g. within 1.2 hours, 1.0 hour, 50 minutes, 40 minutes, 30 minutes, 20 minutes, 10 minutes, 5 minutes, an minute, or the like). The lower limit of the high pressure time under the condition of 100 atmospheres or more may be properly set depending on a desired adsorption ability of an adsorbing agent. The lower limit is preferably, for example, 10 seconds or more, 30 seconds or more, a minute or more, 10 minutes or more, 30 minutes or more, and an hour or more, for example, from the viewpoint of obtaining foam glass having the above-described characteristics.

For the high pressure treatment, for example, an ultra-high pressure device can be used. High pressure can be applied by a high pressure treatment using the above device with a foam glass material included in an alkaline solution in a closed container.

As the foam glass material used in the step of high pressure treatment, for example, a foam glass material obtained by foaming the above-described material glass can be used as described in the method for producing an anionic substance-adsorbing agent according to the first embodiment.

The alkaline solution used in the step of high pressure treatment is a solution obtained by dissolving a solute, which is dissolved in water to generate hydroxy group, in water. The type of solute in an alkaline solution is not particularly limited, and, for example, one or more selected from the group consisting of NaOH, KOH, Na₂CO₃ and Ca(OH)₂ can be used. Among these, NaOH or KOH, a strong alkali, is particularly preferred.

When the solute is NaOH or KOH, the concentration of an alkaline solution is preferably 0.5 mol/L or more, further preferably 3 mol/L or more, and further preferably 4 mol/L or more. When the concentration is 3 mol/L or more, the amount of anionic substances (particularly phosphoric acid ion) adsorbed is particularly high, and when the concentration is 4 mol/L or more, the amount of anionic substances (particularly phosphoric acid ion) adsorbed is further high. In addition, when the solute is NaOH or KOH, the concentration of an alkaline solution may be, for example, 19 mol/L or less (18 mol/L or less, 17 mol/L or less, or the like).

The temperature in the step of high pressure treatment is not particularly limited as long as the temperature is, for example, from room temperature to 200° C., and the temperature is preferably 80° C. or higher and more preferably 90° C. or higher from the viewpoint of obtaining an adsorbing agent having the above-described characteristics. The temperature can be regulated by the above-described device to apply pressure.

In the production of the anionic substance-adsorbing agent of the present invention, a known step different from the above-described step of high temperature alkali treatment and step of high pressure treatment may or may not be further included. Examples of such step can include a washing step.

The washing step can remove an alkaline solution adhering to foam glass after the above step of high temperature alkali treatment and step of high pressure treatment. The method for this washing is not particularly limited as long as an alkaline solution can be removed, and washing can be carried out using, for example, water, an acid solution or a pH buffer solution. In addition, when a case where an alkaline solution adheres to foam glass is not a problem, the step of washing treatment can be omitted.

### <Apparatus for Producing Anionic Substance-Adsorbing Agent>

The present invention includes an apparatus for producing an anionic substance-adsorbing agent, the apparatus including a means for treating a foam glass material in an alkaline solution including an alkali metal hydroxide in an amount of 4 mol/L or more and having 130° C. or higher over a time required.

In the method for producing the anionic substance-adsorbing agent, the present invention can use a device which can carry out a heating treatment in an alkaline solution including an alkali metal hydroxide in an amount of 4 mol/L or more and having 130° C. or higher.

In addition, the present invention includes an apparatus for producing an anionic substance-adsorbing agent, the apparatus including a means which can apply high pressure to foam glass in an alkaline solution under the condition of 100 atmospheres or more within 1.5 hours.

In the method for producing an anionic substance-adsorbing agent, the present invention can use a device which can apply high pressure, 100 atmospheres or more.

### <Method for Recovering Anionic Substances>

The present invention includes a method for recovering anionic substances, the method having the step of adsorbing anionic substances to the above-described anionic substance-adsorbing agent.

As a method for adsorbing anionic substances to an adsorbing agent, for example, by immersing the above adsorbing agent in a solution including phosphoric acid ion or fluoride ion, phosphoric acid ion and fluoride ion in the solution can be adsorbed to the adsorbing agent. As the solution including phosphoric acid ion, a liquid in which phosphoric acid ion is included is not particularly limited, and examples thereof include domestic drainage, agricultural drainage and the like. As the solution including fluoride ion, a liquid in which fluoride ion is included is not particularly limited, and examples thereof include a semiconductor washing liquid, a hydrofluoric acid-containing solution used to process and wash glasses, and the like.

The pH of a solution including phosphoric acid ion is not particularly limited, and is preferably 2.4 to 7.7, more preferably 2.8 to 6.8, and further preferably 3.8 to 6. When the pH is within this range, the amount of phosphoric acid ion adsorbed increases. In addition, when the pH of a solution including phosphoric acid ion is outside the above range, it is preferred to include the step of pH adjustment to adjust the pH of the solution including phosphoric acid ion within the above range by adding an acid or base. The pH of a solution including fluoride ion is not particularly limited, and is preferably 1.4 to 7.2, more preferably 1.8 to 6.3, and further preferably 2.2 to 5.3. When the pH is within this range, the amount of fluoride ion adsorbed increases. In addition, when the pH of a solution including fluoride ion is outside the above range, it is preferred to include the step of pH adjustment to adjust the pH of the solution including fluoride ion within the above range by adding an acid or base.

After an adsorbing agent adsorbs phosphoric acid ion, the adsorbing agent may be pulverized and used as a raw material for e.g. a phosphoric acid fertilizer or feed.

In addition, anionic substances may be recovered by desorbing the anionic substances (e.g. phosphoric acid ion) from the adsorbing agent using a strong acid such as nitric acid in place of pulverizing the adsorbing agent. In this case, the concentration of strong acid is not particularly limited, and is preferably 0.01 mol/L or more, more preferably 0.05 mol/L or more, and further preferably 0.1 mol/L or more. In a case where the concentration is 0.05 mol/L or more, the recovery rate of anionic substances (particularly phosphoric acid ion) increases, and in a case where the concentration is 0.1 mol/L, the recovery rate of anionic substances (particularly phosphoric acid ion) particularly increases. In addition, the upper limit of the concentration of strong acid is not particularly limited, and may be, for example, 3 mol/L or less. It should be noted that an anionic substance-adsorbing agent from which anionic substances have been desorbed can adsorb anionic substances again.

### EXAMPLES

### Test Example 1

The adsorption ability of an adsorbing agent (the amount of phosphoric acid ion adsorbed) was evaluated based on the concentration of Ca2p and the concentration of Na1s on the surface of the adsorbing agent by XPS analysis.

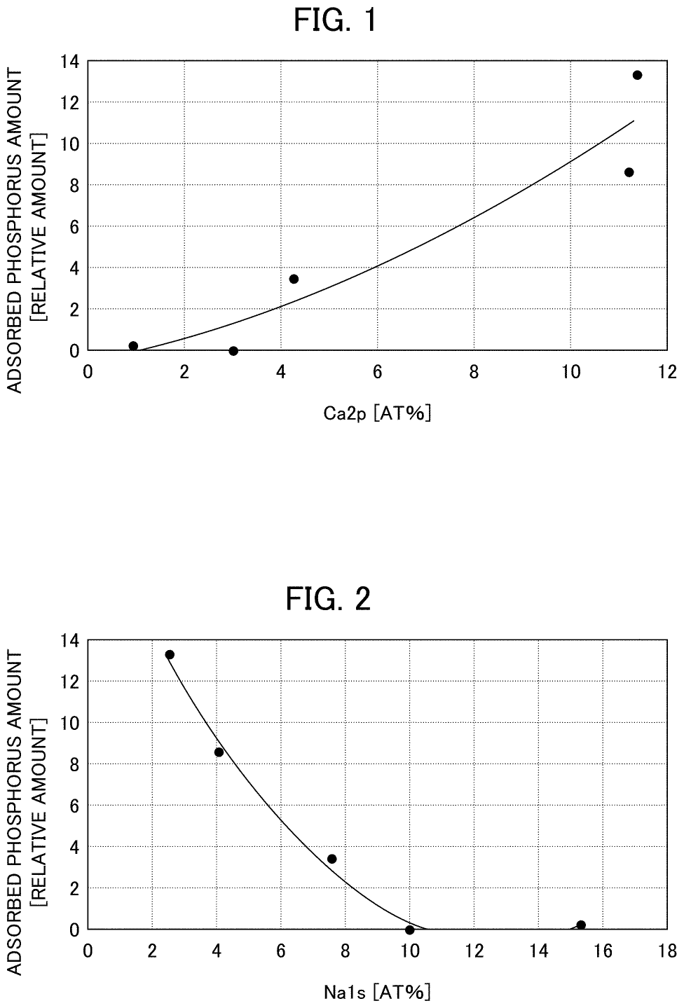

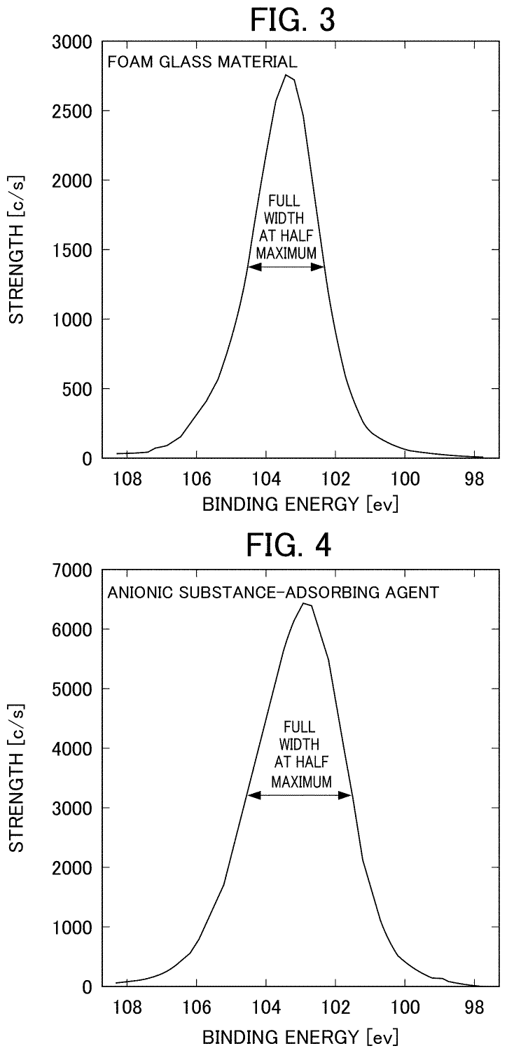

Specifically, a foam glass material A produced using calcium carbonate as a foaming agent was prepared. Next, this foam glass material A was subjected to a high temperature alkali treatment by a sodium hydroxide solution with a NaOH concentration of 5.5 mol/L while properly adjusting the treatment pressure, treatment temperature and treatment time to produce adsorbing agents in which the concentration of Ca2p and the concentration of Na1s on a foam glass surface were adjusted. The amounts of phosphoric acid ion adsorbed by the adsorbing agents each having different Ca2p concentrations and Na1s concentrations were each measured by [the method for measuring the amount of phosphoric acid ion which can be adsorbed in high concentration phosphoric acid ion solution] described in the above-described “PREFERRED MODE FOR CARRYING OUT THE INVENTION.” The results are shown as the adsorbed phosphorus amount [relative amount] in FIG. 1 and FIG. 2. In addition, the peak region of Si2p of the foam glass material A by XPS analysis is shown in FIG. 3, and the peak region of Si2p of an adsorbing agent (foam glass) produced by a high temperature alkali treatment of the foam glass material A is shown in FIG. 4.

The results in FIG. 1 and FIG. 2 verified that as the concentration of Ca2p on the surface of an adsorbing agent increased, the adsorbed phosphorus amount increased, and as the concentration of Na1s on the surface of an adsorbing agent decreased, the adsorbed phosphorus amount increased. When the concentration of Ca2p was 4.0 at % or more and the concentration of Na1s was 8.0 at % or less on the surface of an adsorbing agent, the amount of phosphoric acid ion which could be adsorbed was 20 mg/g or more in both cases, which verified that an excellent adsorption ability was shown.

In addition, the results in FIG. 3 and FIG. 4 verified that the full width at half maximum was narrow due to more —SiO₂ and less —SiOX in the foam glass material A, while the full width at half maximum was large due to less —SiO₂ and more —SiOX by the alkali treatment in foam glass, which becomes an adsorbing agent. In this adsorbing agent (foam glass) in which the full width at half maximum is 2.4 eV or more, —SiOX, the basic skeleton of glass, remains without being destroyed even after the alkali treatment, and this —SiOX contributes to the adsorption of phosphoric acid ion to show an ability to adsorb phosphoric acid ion.

### Test Example 2

The amount of phosphoric acid ion adsorbed by an adsorbing agent was evaluated based on the specific surface area and pore volume by a mercury intrusion method. In addition, the amount of phosphoric acid ion adsorbed by an adsorbing agent was evaluated based on the specific gravity measured by the method described in the above-described “PREFERRED MODE FOR CARRYING OUT THE INVENTION.”

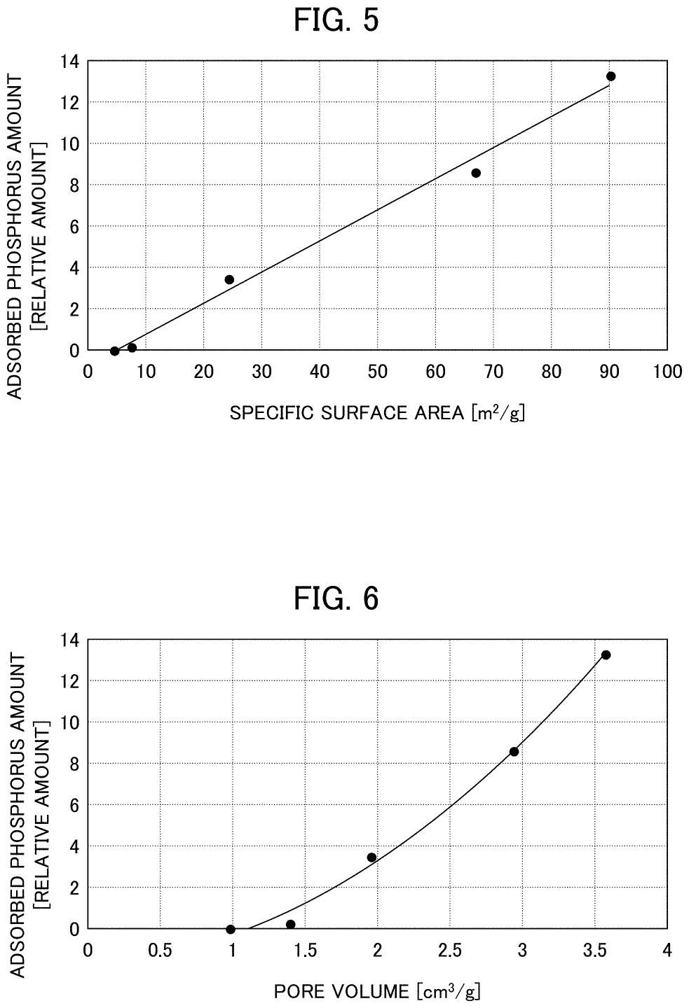

Specifically, the foam glass material A prepared in Test Example 1 was subjected to a high temperature alkali treatment by a sodium hydroxide solution with a NaOH concentration of 5.5 mol/L while properly adjusting the treatment pressure, treatment temperature and treatment time to produce adsorbing agents in which the specific surface area, pore volume and specific gravity on a foam glass surface were adjusted. The amounts of phosphorus which could be adsorbed by the adsorbing agents each having different specific surface areas, pore volumes and specific gravities were each measured by the above-described [method for measuring the amount of phosphoric acid ion which can be adsorbed in high concentration phosphoric acid ion solution]. The results are shown as the adsorbed phosphorus amount [relative amount] in FIG. 5 to FIG. 7.

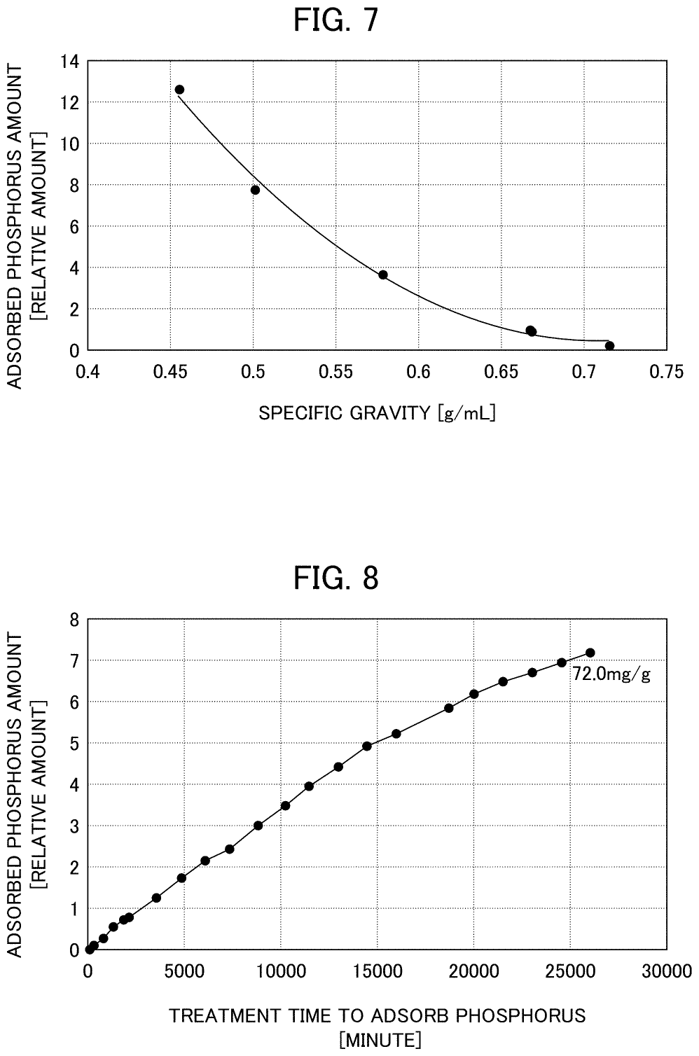

The results in FIG. 5 verified that as the specific surface area of an adsorbing agent increased, the adsorbed phosphorus amount increased. In addition, the results in FIG. 6 verified that as the pore volume of an adsorbing agent increased, the adsorbed phosphorus amount increased. In addition, the results in FIG. 7 verified that as the specific gravity of an adsorbing agent decreased, the adsorbed phosphorus amount increased. When the specific surface area of an adsorbing agent was 15 m²/g or more, the pore volume was 1.7 cm³/g or more, or the specific gravity was 0.60 g/mL or less, the amount of phosphoric acid ion which could be adsorbed was 10 mg/g or more in all cases, which verified that an excellent ability to adsorb phosphoric acid ion was shown.

### Test Example 3

The foam glass material A used in Test Example 1 was subjected to a high temperature alkali treatment at a NaOH concentration of 5.0 mol/L, a treatment pressure of 5 atmospheres, a treatment temperature of 150° C. for a treatment time of 30 minutes to produce a foam glass with a specific gravity of 0.50 g/mL. When the foam glass was used as an adsorbing agent and measurement was carried out by the above-described [method for measuring the amount of phosphoric acid ion which can be adsorbed in high concentration phosphoric acid ion solution], the amount of phosphoric acid ion which could be adsorbed was 77.8 mg/g. Using this adsorbing agent the amount of phosphoric acid ion which could be adsorbed was measured by a [method for measuring the amount of phosphoric acid ion which can be adsorbed in low concentration phosphoric acid ion solution] described below. The results are shown in FIG. 8.

[Method for Measuring Amount of Phosphoric Acid Ion which can be Adsorbed in Low Concentration Phosphoric Acid Ion Solution]

(1) A column filled with 2.50 g of adsorbing agent, and a water tank with 500 mL of a phosphoric acid ion solution with a concentration of phosphoric acid ion (PO₄³⁻) of 30 mg/L are prepared.

(2) The phosphoric acid ion solution in the water tank is allowed to flow using a pump at a flow rate of 1.0 mL/min in a direction from the lower part to the upper part of the column. The solution having passed through the column is recovered in the water tank again, and circulation between the water tank and the column is repeated. In addition, the pH of the phosphoric acid ion solution is adjusted to a desired pH by adding hydrochloric acid or a sodium hydroxide solution during circulation.

(3) The phosphoric acid ion solution in the water tank is collected after a lapse of a constant time from the onset of operation and measured with an absorptiometer by a molybdenum blue method.

(4) The amount of phosphoric acid ion adsorbed (mg/g) is found based on the measurement value.

(5) The concentration of PO₄³⁻ in the phosphoric acid ion solution in the water tank is adjusted to 30 mg/L.

(6) The operation from (2) to (5) is repeated until the amount of phosphoric acid ion adsorbed to the adsorbing agent is saturated.

(7) The total amount of phosphoric acid ion adsorbed until saturation is used as the amount of phosphoric acid ion which can be adsorbed (mg/g).

As can be seen from the results in FIG. 8, in the measurement of the amount of phosphoric acid ion which can be adsorbed in a low concentration phosphoric acid ion solution, the value was above 72.0 mg/g for 25000 minutes. That is, the achievement rate of the adsorbed phosphorus amount in a low concentration phosphoric acid ion solution to that in a phosphoric acid ion solution in the high concentration range is 72.0 (mg/g)/77.8 (mg/g)×100=92.5(%). This verified that the adsorbing agent used in Test Example 3 showed an excellent ability to adsorb phosphoric acid ion in the whole concentration range of a phosphoric acid ion solution from the low concentration range to the high concentration range.

### Test Example 4

In Test Example 4, the ability to adsorb fluoride ion of an adsorbing agent was examined.

Specifically, 0.2 g of the adsorbing agent produced in Test Example 1 (Ca2p concentration: 11.4 at %, Na1s concentration: 2.5 at %) and 20 mL of a sodium fluoride solution with a fluoride ion concentration shown in Table 1 were put in a container. The pH is adjusted to a desired pH by adding hydrochloric acid or a sodium hydroxide solution to the container. After pH adjustment, the container was stirred for a constant time in a thermostatic bath set to 25° C. Centrifugation was carried out at 3000 rpm for 10 minutes after stirring, and the concentration of fluoride ion in a supernatant liquid was measured by a colorimetric method. The adsorbed fluorine amount [mg/g] was calculated based on this measurement value. The results are shown in Table 1.

TABLE 1

| Concentration | | | |
|---|---|---|---|
| of fluoride ion in | | | Absorbed fluoride |
| sodium fluoride solution | Stirring time | | amount |
| [mg/L] | [hour] | pH | [mg/g] |
| 10000 | 48 | 2.2 | 846 |
| 15000 | 20 | 5.3 | 1070 |

The results in Table 1 verified that the adsorbing agent produced in Test Example 1 showed an excellent ability to adsorb not only phosphoric acid ion but also fluoride ion.

### Test Example 5

In Test Example 5, when a foam glass material was subjected to an alkali treatment, the influence of the concentration of NaOH and temperature of an alkaline solution on the amount of phosphoric acid ion adsorbed was examined.

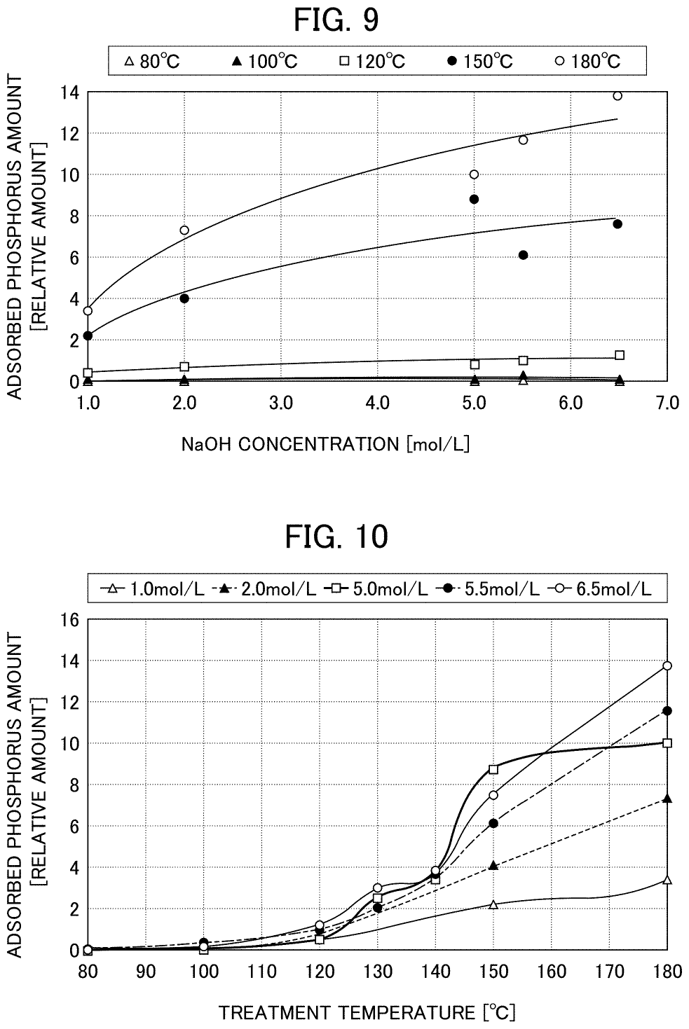

Specifically, the foam glass material A used in Test Example 1 was subjected to an alkali treatment for an hour while properly adjusting the concentration of NaOH in an alkaline solution to 1.0 to 6.5 mol/L, the temperature of the alkaline solution to 80 to 180° C., the treatment pressure to 0.2 to 10 atmospheres to produce foam glasses. A foam glass produced in each of these conditions was used as an adsorbing agent, and the amount of phosphoric acid ion which could be adsorbed by the adsorbing agent was measured by the above-described [method for measuring the amount of phosphoric acid ion which can be adsorbed in high concentration phosphoric acid ion solution]. The results are shown as the adsorbed phosphorus amount [relative amount] in FIG. 9 and FIG. 10.

As can be seen from the results in FIG. 9 and FIG. 10, in a case where a foam glass obtained by an alkali treatment at a NaOH concentration in an alkaline solution of 4.0 mol/L or more and an alkaline solution temperature (treatment temperature) of 130° C. or higher was used as an adsorbing agent, the adsorbed phosphorus amount considerably increased compared to that of a case where the temperature of an alkaline solution was 120° C. or lower. From this it is found that an adsorbing agent produced by a high temperature alkali treatment on the conditions that the concentration of NaOH in an alkaline solution be 4.0 mol/L or more and the temperature of an alkaline solution be 130° C. or higher shows an excellent ability to adsorb phosphoric acid ion.

### Test Example 6

In Test Example 6, when a foam glass material is subjected to an alkali treatment, a relationship between the treatment time and the amount of phosphoric acid ion adsorbed was examined.

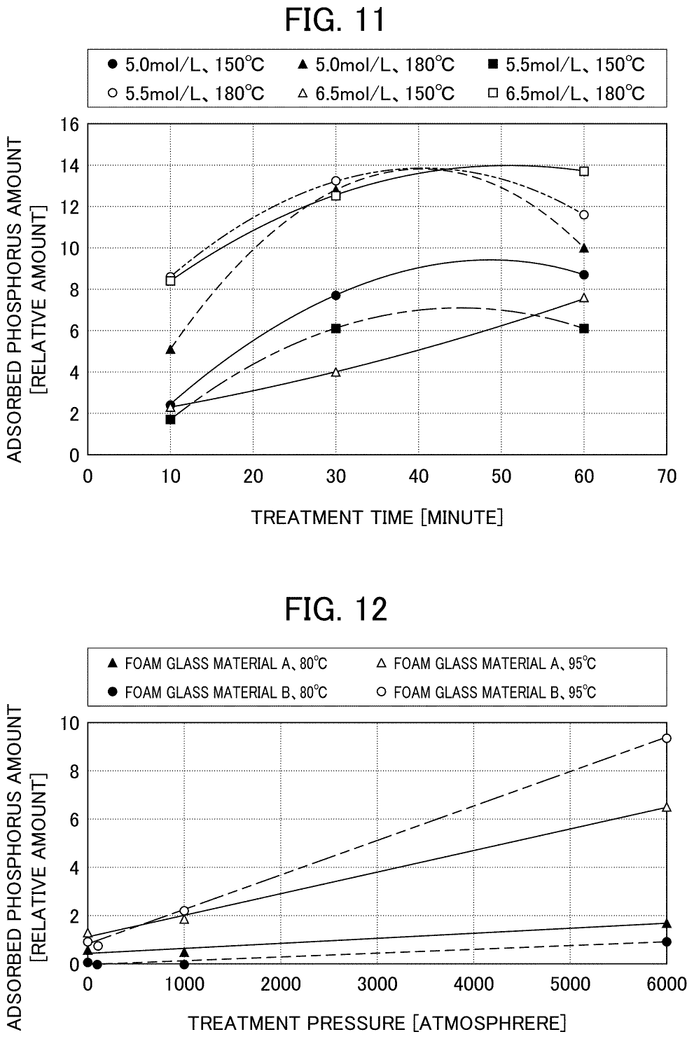

Specifically, the foam glass material A used in Test Example 1 was subjected to an alkali treatment while adjusting the concentration of NaOH in an alkaline solution to 5.0, 5.5 or 6.5 mol/L, the temperature of an alkaline solution to 150 or 180° C., the treatment pressure to 5 or 10 atmospheres to produce foam glasses. A foam glass produced in each of these conditions was used as an adsorbing agent, and the amount of phosphoric acid ion which could be adsorbed was measured by the above-described [method for measuring the amount of phosphoric acid ion which can be adsorbed in high concentration phosphoric acid ion solution]. The results are shown as the adsorbed phosphorus amount [relative amount] in FIG. 11.

From the results in FIG. 11, it is found that an excellent ability to adsorb phosphoric acid ion is obtained for a short reaction time, 10 minutes, 30 minutes or an hour by the alkali treatment under the above conditions, and particularly found that as the concentration and temperature of an alkaline solution increase, an excellent ability to adsorb phosphoric acid ion is obtained even when the treatment time is short.

### Test Example 7

In Test Example 7, when a foam glass material was subjected to a high pressure treatment, the influence of the temperature of an alkaline solution and the treatment pressure on the amount of phosphoric acid ion adsorbed was examined.

Specifically, the foam glass material A used in Test Example 1 was subjected to a high pressure treatment for an hour while adjusting the concentration of NaOH in an alkaline solution to 5.0 mol/L, the temperature of an alkaline solution to 80° C. or 95° C., and the treatment pressure to 0, 100, 1000 or 6000 atmospheres to produce foam glasses. In addition, a foam glass material B produced using silicon carbide as a foaming agent was prepared. This foam glass material B was subjected to the same high pressure treatment as the foam glass material A to produce a foam glass. A foam glass produced in each of these conditions was used as an adsorbing agent, and the amount of phosphoric acid ion which could be adsorbed was measured by the above-described [method for measuring the amount of phosphoric acid ion which can be adsorbed in high concentration phosphoric acid ion solution]. The results are shown as the adsorbed phosphorus amount [relative amount] in FIG. 12.

As can be seen from the results in FIG. 12, in the case of a high pressure treatment under the condition of an alkaline solution temperature of 95° C., as the treatment pressure increased to 100 atmospheres or more, the amount of phosphorus adsorbed by an adsorbing agent considerably increased compared to the case of a high pressure treatment under the condition of an alkaline solution temperature of 80° C. in both cases of the foam glass material A and the foam glass material B. In addition, it was verified that an adsorbing agent produced by a high pressure treatment at 6000 atmospheres at an alkaline solution temperature of 95° C. showed a particularly excellent adsorbed phosphorus amount.

### Test Example 8

An adsorbing agent having adsorbed phosphoric acid ion was treated to desorb phosphoric acid using nitric acid, and the recovery rate of phosphoric acid ion was examined.

Specifically, an adsorbing agent which had adsorbed 99.6 mg/g of phosphoric acid ion, and a nitric acid solution with a predetermined concentration were put in a container, and the obtained mixture was stirred in a thermostatic bath set to 25° C. for 2 or 4 hours. After completion of stirring, centrifugation was carried out at 3000 rpm for 10 minutes, and the concentration of phosphoric acid ion in a supernatant liquid was measured using an absorptiometer by a molybdenum blue method. The recovery rate of phosphoric acid ion was calculated based on the measurement value. The results are shown in Table 2.

TABLE 2

| | | | | Concentration of | |
|---|---|---|---|---|---|
| | | | | phosphonic | |
| Added amount of | Concentration of | | | acid ion in | Recovery rate of |
| adsorbent | nitric acid | Stirring time | Supernatant | supernatant liquid | phosphoric acid ion |
| [g] | [mol/L] | [hour] | liquid pH | [mg/L] | [%] |
| 0.215 | 0.1 | 4 | 1.57 | 1095 | 102 |
| 0.211 | 1 | 2 | 0 or less | 1015 | 97 |

The results in Table 2 verified that phosphoric acid ion could be recovered from an adsorbing agent having adsorbed phosphoric acid ion at a high recovery rate.

1-11. (canceled)

12. An anionic substance-adsorbing agent, which contains foam glass,
wherein by XPS analysis a concentration of Ca2p is 4.0 at % or more or a concentration of Na1s is 8.0 at % or less on a surface of the adsorbing agent, and a full width at half maximum of a Si2p peak is 2.4 eV or more.

13. The adsorbing agent according to claim 12, wherein by a mercury intrusion method a specific surface area is 15 m²/g or more or a pore volume is 1.7 cm³/g or more.

14. The adsorbing agent according to claim 12, wherein a specific gravity is 0.60 g/mL or less.

15. The adsorbing agent according to claim 12, wherein an amount of phosphoric acid ion which can be adsorbed in a phosphoric acid ion solution with a concentration of phosphoric acid ion of 3000 mg/L or more is 10 mg/g or more.

16. A method for producing an anionic substance-adsorbing agent, the method having a step of treating a foam glass material in an alkaline solution comprising an alkali metal hydroxide in an amount of 4 mol/L or more and having 130° C. or higher over a time required.

17. The method according to claim 16, wherein the time required is within 1.5 hours.

18. The method according to claim 16, wherein the foam glass material has been foamed with a foaming agent comprising calcium carbonate.

19. An apparatus for producing an anionic substance-adsorbing agent, the apparatus comprising:
a means of treating a foam glass material in an alkaline solution comprising an alkali metal hydroxide in an amount of 4 mol/L or more and having 130° C. or higher over a time required.

20. A method for recovering anionic substances, comprising:
a step of adsorbing anionic substances to an adsorbing agent according to claim 12, or an adsorbing agent produced treating a foam glass material in an alkaline solution comprising an alkali metal hydroxide in an amount of 4 mol/L or more and having 130° C. or higher over a time required.
